(19) United States
(12) Patent Application Publication
(10) Pub. No.: US 2008/0092698 A1
(43) Pub. Date: Apr. 24, 2008

(54) Lockable adjustable tool grip

(76) Inventor: David A. Duncan, LeClaire, IA (US)

Correspondence Address: LAW OFFICE OF JAY R. HAMILTON, PLC., 331 W. 3RD ST., NEW VENTURES CENTER SUITE 120, DAVENPORT, IA, 52801, US

(21) Appl. No.: 11/820,227

(22) Filed: Jun. 19, 2007

Related U.S. Application Data
(60) Provisional application No. 60/814,755, filed on Jun. 19, 2006.

(51) Int. Cl. B25B 7/12

(52) U.S. Cl. 81/378

(57) ABSTRACT

A gripping tool is disclosed. The gripping tool comprises a rod handle having a first and second end, wherein said rod handle first end is coupled to an engagement surface, and wherein said rod handle second end is adapted to receive an adjustment means; a non-rod handle having a first and second end, wherein said non-rod handle first end is coupled to an engagement surface, wherein said non-rod handle second end provides a user interface, and wherein said non-rod handle is engaged to and movable relative to said rod handle; and a securing means adapted to secure the position of said adjustment means, wherein said securing means engages said adjustment means in a manner different than the manner in which said rod handle receives said adjustment means, and wherein said adjustment means controls the distance between said engagement surfaces.

### CROSS REFERENCE TO RELATED APPLICATIONS

Applicant claims priority under 35 U.S.C. §119(e) of provisional U.S. Patent Application Ser. No. 60,814,755 filed on Jun. 19, 2006, which is incorporated by reference herein.

### FIELD OF INVENTION

An apparatus to lock the threaded rod of any tool employing a threaded rod axially disposed with a cylindrical structure circumferentially enveloping at least a portion of the threaded rod, wherein the threaded rod is used to adjust the clearance between the gripping means of the tool.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### BRIEF DESCRIPTION OF THE DRAWINGS

FIG. 1 provides a side view of a first embodiment of the present invention.

FIG. 2 provides a detailed, partial cutaway view of a portion of the rod handle of the first embodiment of the present invention.

FIG. 3 provides a detailed, partial cutaway view of a portion of the rod handle of a second embodiment of the present invention.

FIG. 4 provides a detailed, perspective view of the threaded rod used with the second and third embodiments of the present invention.

FIG. 5 provides a side view of a third embodiment of the present invention.

FIG. 6 provides a detailed view of the distal end of the rod handle of the third embodiment of the present invention.

FIG. 7A provides a cross-sectional view of the rod handle showing the engagement ball in the third embodiment seated in an axial groove of the threaded rod.

FIG. 7B provides a cross-sectional view of the rod handle showing the engagement ball in the third embodiment not seated in an axial groove of the threaded rod.

DETAILED DESCRIPTION - LISTING OF ELEMENTS

| Element Description | Element Number |
|---|---|
| Gripping Tool | 1 |
| Engagement Surface | 2 |
| Threaded Rod | 3 |
| Threaded Rod Grip | 4 |
| Screw | 5 |
| Rod Handle | 6 |
| Non-Rod Handle | 7 |
| Threaded Chamber | 8 |
| Intentionally Left Blank | 9 |
| Axial Groove | 10 |
| Engagement Ball | 11 |
| Jaw Release Lever | 12 |
| Jaw Clearance | 13 |
| Spring Mechanism | 14 |
| Spring Band | 15 |
| Annular Groove | 16 |

### DETAILED DESCRIPTION

The invention described herein provides an improvement to adjustable gripping tools. The invention provides a means to lock the threaded rod 3 of any tool employing a threaded rod 3 axially disposed with a cylindrical structure circumferentially enveloping at least a portion of the threaded rod 3, wherein the threaded rod 3 is used to adjust the clearance between the engagement surfaces 2 of the gripping tool 1. In the specific embodiments disclosed and described herein, the present invention has been applied to the structure disclosed in U.S. Pat. No. 2,641,149, but as noted above, the present invention applies to the entire class of tools employing a threaded rod 3 axially disposed with a cylindrical structure circumferentially enveloping at least a portion of the threaded rod 3 wherein the threaded rod is used to adjust the jaw clearance 13, and is not limited by the specific embodiments described and disclosed herein.

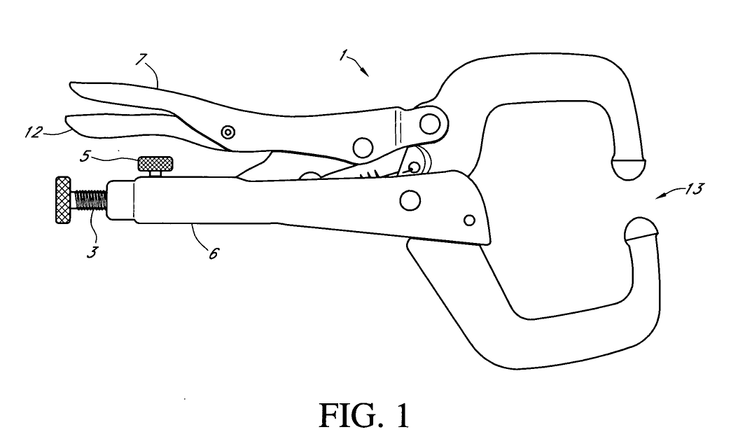

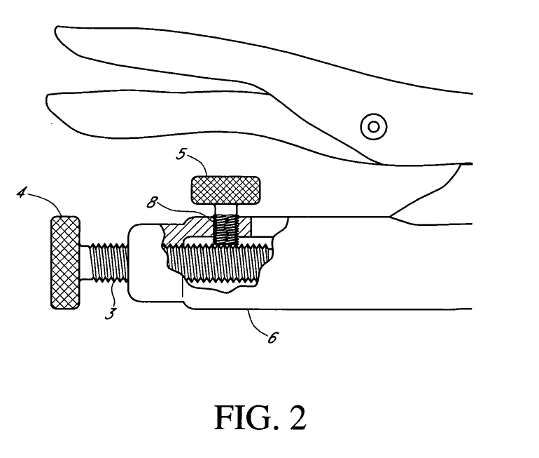

Referring now to the drawings, wherein similar reference numerals designate similar or identical elements, FIG. 1 shows a first embodiment of the present invention. The embodiment employs a screw 5 mounted on the handle through which the threaded rod 3 passes, which handle is hereinafter referred to as the rod handle 6, to adjust the jaw clearance 13, as is well known in the prior art. As shown in FIG. 2, the rod handle 6 is fitted with a threaded chamber 8 that is oriented transverse with respect to the threaded rod 3. The screw 5 passes through the threaded chamber 8 and engages the threaded rod 3 when the screw 5 is tightened, so that the screw 5 locks the position of the threaded rod 3 and does not allow the threaded rod 3 to rotate. The threaded rod grip 4 is positioned at the distal end of the threaded rod 3 and provides the user interface for rotating the threaded rod 3. Once the jaw clearance 13 has been set (by adjusting the position of the threaded rod 3) and the gripping tool 1 has been engaged with the object desired to be gripped, the jaw release lever 12 may be used to release the engagement surface 2 from the gripped object, as is well known in the prior art.

As shown in FIGS. 1 and 2, the threaded chamber 8 is positioned towards the interior portion of the gripping tool 1 and extends from the rod handle 6 towards the non-rod handle 7 so that it is protected from foreign objects on one side by the rod handle 6 and on the opposite side by the non-rod handle 7. In the specific embodiment shown in FIG. 2, the end of the screw 5 which engages the threaded rod 3 is blunt. However, in alternative embodiments that end of the screw 5 may be pointed, and the pitch of the point may be fashioned to emulate the pitch of the threads on the threaded rod 3 so that when the screw 5 is fully engaged with the threaded rod 3, the screw 5 does not damage the threads on the threaded rod 3. The opposite end of the screw 5, which provides the user interface, is fashioned to allow the user to tighten and loosen the screw 5 easily as needed. This end of the screw 5 may be fashioned so that the user may tighten and loosen the screw with the user's bar hands, or it may be fashioned so that another tool is needed to securely tighten the screw 5. The screw 5 is of such an axial dimension as to not interfere with the operation of the rod handle 6 and non-rod handle 7 when the jaw clearance 13 is at the minimum allowed by the gripping tool 1 and the engagement surfaces 2 are in the locked position. When the threaded rod 3 is set for a desired jaw clearance 13, the screw 5 may then be tightened to engage the threaded rod 3 so that the threaded rod 3 does not rotate. Therefore, the jaw clearance 13 remains constant even after a plurality of engagements and disengagements of the gripping tool 1 with the gripping target. The jaw clearance 13 will remain constant when the screw 5 is engaged with the threaded rod 3 regardless of the tool being moved, inadvertent attempts by the user to rotate the threaded rod 3, or changes in the environment of the type that would normally cause the threaded rod 3 to rotate a certain amount (resulting in a change in the jaw clearance 13), such as placement in and removal from a tool storage device, or any other stimuli that might cause jaw clearance 13 to change. When the screw 5 is engaged with the threaded rod 3, the threaded rod 3 will not rotate until the screw 5 has been loosened and disengaged from the threaded rod 3.

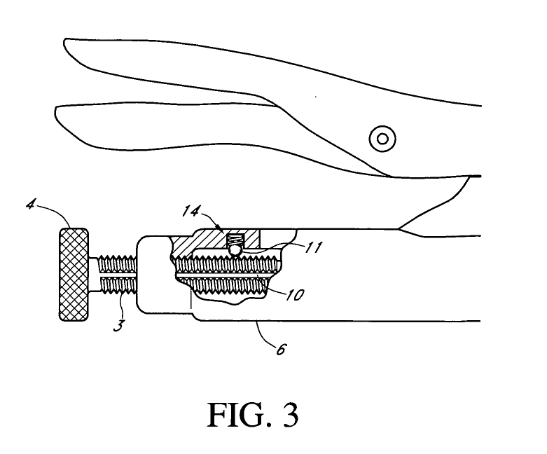

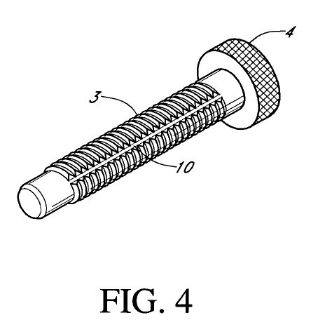

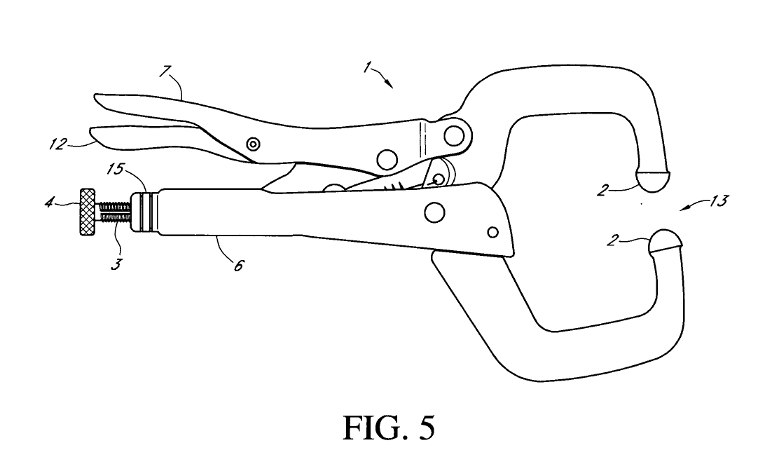

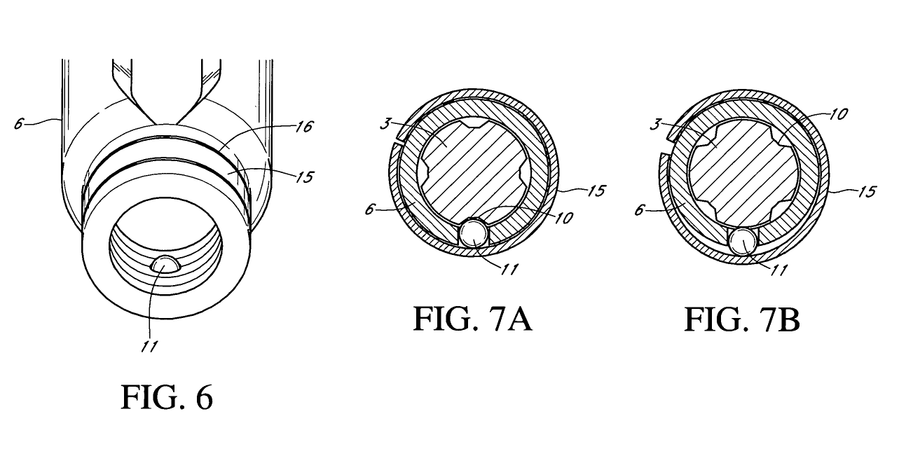

In the second and third embodiments, shown in FIGS. 3 and 5 in which the present invention has again been applied to the gripping tool 1 disclosed in U.S. Pat. No. 2,641,149, an engagement ball 11 in cooperation with axial groove 10 fashioned in the threaded rod 3 is employed to prevent the threaded rod 3 from inadvertently being rotated. The threaded rod 3, shown in detail in FIG. 4, is fashioned with a plurality of axial groves 10 disposing a radial portion of the threads on the threaded rod 3 at predetermined circumferential positions around the periphery of the threaded rod 3. In the embodiment shown in FIGS. 7A and 7B, the threaded rod 3 is fashioned with an axial groove 10 every ninety degrees, in another embodiment the threaded rod 3 is fashioned with an axial groove 10 every one hundred eighty degrees, but the present invention is not limited by the number or location of axial grooves 10 fashioned in the threaded rod 3. As seen in FIG. 3, in the second embodiment the engagement ball 11 is mounted on the rod handle 6 and biased in the radial direction towards the threaded rod 3 by a spring mechanism 14. As see in FIG. 6, in the third embodiment the engagement ball 11 is biased in the radial direction towards the threaded rod 3 by a spring band 15. Any biasing means known to those skilled in the art may be used to bias the engagement ball 11 towards the threaded rod 3, and therefore the scope of the present invention is not limited by choice of biasing means.

The number and location of axial grooves 10 fashioned in the threaded rod 3 and the threads of the threaded rod 3 may cooperate so that the rotation of the threaded rod 3 from one axial groove 10 to an adjacent axial groove 10 will affect the jaw clearance 13 by a predetermined amount at a constant pressure of the engagement surfaces 2 on the item to be gripped. For example, in one embodiment, the threads and the axial grooves 10 on the threaded rod 3 could be fashioned so that rotating the threaded rod 3 from one axial groove 10 to the adjacent axial groove 10 caused the jaw clearance to change by 1/32 of an inch at an engagement surface 2 pressure of 100 pounds per square inch. This type of embodiment will be especially useful in applications where the user of the gripping tool 1 uses the gripping tool 1 to grip objects of known thicknesses. This is one example of an infinite number of embodiments of this type, and modifications and variations will occur without departing from the spirit and scope of the present invention. The present invention extends to any arrangement of axial grooves 10 and threads on a threaded rod 3 of a gripping tool 1 wherein the rotation of the threaded rod 3 from one axial groove 10 to an adjacent axial groove 10 changes the jaw clearance 13 by a predetermined amount at a given engagement surface 2 pressure on the gripped object.

In the second embodiment, as shown in FIG. 3, the disclosed biasing means is an enclosed spring mechanism 14 mounted on the interior side of the rod handle 6. The spring mechanism 14 directly communicates with the engagement ball 11 to bias the engagement ball 11 radially towards the threaded rod 3. The spring mechanism 14 urges the engagement ball 11 to seat within an axial groove 10 fashioned in the threaded rod 3.

In the third embodiment as shown in FIGS. 5, 6, 7A, and 7B, the biasing means is a spring band 15 circumferentially engaging at least the axial portion of the rod handle 6 in which the engagement ball 11 is positioned. The spring band 15 communicates directly with the engagement ball 11 by biasing it radially towards the threaded rod 3. The spring band 15 may be made flush with the rod handle 6 by fashioning an annular groove 16 in the rod handle 6 having the same axial and radial dimensions as the spring band 15.

In the third embodiment, the engagement ball 11 communicates with the threaded rod 3 through a hole in the distal portion of the rod handle 6, as easily may be seen in FIG. 6. The hole in the rod handle 6 may be fashioned so that if the threaded rod 3 is entirely removed from the rod handle 6 the engagement ball 11 will not be dislodged, yet also allow the engagement ball 11 to move in a radial direction towards the threaded rod 3 by an amount sufficient to ensure the engagement ball 11 will adequately seat within an axial groove 10. In an arrangement not shown, the second embodiment may also employ a hole through the distal portion of the rod handle 6, and the hole in the rod handle 6 may be fashioned to achieve the same functionality as described above for the third embodiment. In that arrangement, the spring mechanism 14 would be located further (in a radial direction) from the threaded rod 3 when compared to the location of the spring mechanism 14 as shown in FIG. 3.

In both the second and third embodiments, when the engagement ball 11 is rotationally aligned with an axial groove 10 in the threaded rod 3 (as shown for the third embodiment in FIG. 7A), the biasing means acts on the engagement ball 11 and forces the engagement ball 11 to seat in the axial groove 10. To unseat the engagement ball 11 from the axial groove 10, the threaded rod 3 must be turned with enough force to overcome the radial biasing force that the biasing means places on the engagement ball 11 and the relevant frictional forces. As is readily apparent, the threaded rod 3 will require less force to rotate when the engagement ball 11 is not seated in one of the axial grooves 10 (i.e., when the engagement ball 11 is engaged with the threads of the threaded rod as shown for the third embodiment in FIG. 7B) than the force required to rotate the threaded rod 3 when the engagement ball 11 is seated in an axial groove 10. The extra force required to rotate the threaded rod 3 when the engagement ball 11 is seated in an axial groove 10 ensures the threaded rod 3 will not be inadvertently rotated if the gripping tool 1 or the threaded rod grip 4 is accidentally contacted by the user or another object. If the rotational force applied to the threaded rod grip 4 is large enough to overcome the biasing force the biasing means communicates to the engagement ball 11 in the radial direction when seated in an axial groove 10 and the relevant frictional forces, the engagement ball 11 will be dislodged from the axial groove 10. The threaded rod 3 may then more easily be rotated until the engagement ball 11 is again rotationally aligned with an axial groove 10, at which point the engagement ball 11 will again seat within the axial groove 10. While the engagement ball 11 is seated in one of the axial grooves 10, the jaw clearance 13 for the locked position of the gripping tool 1 will remain constant since the threaded rod 3 will not rotate without dislodging the engagement ball 11 from an axial groove 10.

The amount of force the biasing means communicates to the engagement ball 11 will vary depending on the particular embodiment, according to the application for which the gripping tool 1 is designed. Therefore, the amount of force the biasing means communicate to the engagement ball 11 (and subsequently, the amount of rotational force required to dislodge the engagement ball 11 from an axial groove 10 in which the engagement ball 11 is seated) in no way limits the scope of the present invention. Additionally, the specific dimensions and/or shape of the axial grooves 10 formed in the threaded rod 3 in no way limit the scope of the present invention. The present invention includes an embodiment of axial grooves 10 in which the axial grooves 10 are fashioned so that more rotational force is required to rotate the threaded rod 3 when the engagement ball 11 is seated within an axial groove 10 than when the engagement ball 11 is not seated within an axial groove.

The radial biasing force placed on the engagement ball 11 by the biasing means may be predetermined to such a quantity so that a plurality of engagements and disengagements of the gripping tool 1, normal wear and tear, placement and removal of the gripping tool 1 in a storage container, transporting the gripping tool 1, or any other contemplated stimulus will not change the jaw clearance 13, while simultaneously allowing the threaded rod 3 to be rotated without the assistance of another tool. That is, the biasing force communicated to the engagement ball 11 by the biasing means may be adjusted to whatever value is convenient for a particular application; and this includes a value that allows the user to rotate the threaded rod 3 with the user's bare hands. In this way, the second and third embodiments prevent the threaded rod 3 from being inadvertently rotated. The second and third embodiments also prevent the jaw clearance 13 from drifting (i.e., any inadvertent change in the jaw clearance 13 over time that result from use of the gripping tool 1) as typically caused by normal engagement and disengagement of the gripping tool 1, or any other variables which might cause unwanted rotation of the threaded rod 3. Because the threaded rod 3 in several embodiments of the present invention may be adjusted with the user's bare hands and does not require additional tools or adjustments to other moving parts to secure the position of the threaded rod 3, unlike previous designs, the present invention secures the position of the threaded rod 3 while still retaining the ease of purposeful adjustment of the threaded rod 3 that is available in tools not employing the present invention.

The present invention applies to any and all tools that use a threaded rod 3 to adjust the jaw clearance 13, including but not limited to lockable pliers, C-clamps, rod hangers with threaded engagement surfaces 2, and the like.

It should be noted that the present invention is not limited to the specific embodiments pictured and described herein, but is intended to apply to all similar apparatuses for securing the jaw clearance 13 of gripping tools 1. Modifications and alterations from the described embodiments will occur to those skilled in the art without departure from the spirit and scope of the present invention.

What is claimed is:

1. A gripping tool comprising:
a. a rod handle having a first and second end, wherein said rod handle first end is coupled to an engagement surface, and wherein said rod handle second end is adapted to receive an adjustment means;
b. a non-rod handle having a first and second end, wherein said non-rod handle first end is coupled to an engagement surface, wherein said non-rod handle second end provides a user interface, and wherein said non-rod handle is engaged to and movable relative to said rod handle; and
c. a securing means adapted to secure the position of said adjustment means, wherein said securing means engages said adjustment means in a manner different than the manner in which said rod handle receives said adjustment means, and wherein said adjustment means controls the distance between said engagement surfaces coupled to said rod handle first end and said non-rod handle first end.

2. A gripping tool comprising:
a. a threaded rod fashioned with at least one axial groove along a portion of said threaded rod;
b. an engagement ball fashioned to seat within said at least one axial groove wherein said engagement ball is fashioned to be radially moveable relative to said threaded rod;
c. a rod handle having a first and second end, wherein said rod handle first end is coupled to an engagement surface, wherein said rod handle second end is adapted to receive said threaded rod, and wherein said rod handle second end is further adapted to receive said engagement ball;
d. a non-rod handle having a first and second end, wherein said non-rod handle is engaged to and movable relative to said rod handle, wherein said non-rod handle first end is coupled to an engagement surface, wherein said threaded rod is operable to adjust the distance between said engagement surfaces coupled to said first ends of said rod handle and said non-rod handle, and wherein said non-rod handle second end provides a user interface; and
e. a biasing means affixed to said rod handle second end, wherein said biasing means biases said engagement ball in a radial direction towards said threaded rod.

3. The gripping tool according to claim 2 wherein said biasing means is further defined as a spring mechanism affixed to an interior portion of said rod handle second end.

4. The gripping tool according to claim 2 wherein said biasing means is further defined as a spring band engaging a portion of said rod handle second end.

5. The gripping tool according to claim 2 wherein said threaded rod is fashioned with four axial grooves equally spaced around the periphery of said threaded rod.

6. The gripping tool according to claims 3 or 4 wherein said biasing means biases said engagement ball towards said threaded rod with a force that allows said threaded rod to be rotated with a user's hands, but prevents inadvertent rotation of said threaded rod.

7. The gripping tool according to claim 2 wherein said threaded rod is fashioned with a threaded rod grip on a distal end of said threaded rod.

8. The gripping tool according to claim 2 wherein said axial grooves extend the entire axial length of said threaded rod.

9. The gripping tool according to claim 2 wherein the clearance between said engagement surfaces coupled to said rod handle and said non-rod handle first ends is changed by a predetermined amount at a given pressure between said engagement surfaces upon the rotation of said threaded rod by an angular dimension equal to the angular dimension between two adjacent axial grooves.

10. A gripping tool comprising:
a. a threaded rod;
b. a screw having a first end and a second end;
c. a rod handle having a first and second end, wherein said rod handle first end is coupled to an engagement surface, wherein said rod handle second end is adapted to receive said threaded rod, wherein said rod handle second end is further adapted to receive said screw in a direction transverse to the axial direction of said threaded rod, and wherein either said screw first end or second end is fashioned to be engageable with a portion of said threaded rod; and,
d. a non-rod handle having a first and second end, wherein said non-rod handle is movable relative to said rod handle, wherein said non-rod handle first end is coupled to an engagement surface, wherein said threaded rod is operable to adjust the distance between said engagement surfaces coupled to said first ends of said rod handle and said non-rod handle, and wherein said non-rod handle second end provides a user interface.

11. The gripping tool according to claim 10 wherein said rod handle second end is further defined as being fashioned to receive said screw by means of a threaded chamber in said rod handle second end.

12. The gripping tool according to claim 11 wherein said screw first end is positioned distal with respect to said threaded rod and wherein said screw first end is fashioned with a user interface to allow a user to rotate said screw.

13. The gripping tool according to claim 12 wherein said screw is further fashioned with a pointed interface on said screw second end.

14. The gripping tool according to claim 11 wherein said user interface is further defined as easily being rotatable with the bare hands of a user.

15. The gripping tool according to claim 13 wherein said pointed interface on said screw second end is fashioned so that said pointed interface will not

16. The gripping tool according to claim 1, 2, or 10 wherein said rod handle and said non-rod handle may be locked in a specific position at a set clearance between said engagement surfaces and wherein said gripping tool further comprises a jaw release lever to unlock the position of said rod handle and said non-rod handle.

17. The gripping tool according to claim 1, 2, or 10 wherein said engagement surfaces are fashioned as gripping jaws, C-clamps, or rod hangers.
